(19) United States
(12) Patent Application Publication
(10) Pub. No.: US 2026/0065648 A1
(43) Pub. Date: Mar. 5, 2026

(54) Imaging System and Method for Deploying Greedy Optimization for Training Machine Vision

(71) Applicant: ZEBRA TECHNOLOGIES CORPORATION, Lincolnshire, IL (US)

(72) Inventors: Caelan Marks, Montreal (CA); Dominique Rivard, Deux-Montagnes (CA); Andre Al-Khoury, Mississauga (CA); Pankaj R. Roy, Lachine (CA)

(21) Appl. No.: 18/821,438

(22) Filed: Aug. 30, 2024

(51) Int. Cl. G06V 10/774; G06T 7/00; G06V 10/77; G06V 10/771; G06V 10/82

(52) U.S. Cl. CPC G06V 10/774; G06T 7/0004; G06V 10/771; G06V 10/7715; G06V 10/82; G06T 2207/20016; G06T 2207/20081; G06T 2207/20084

(57) ABSTRACT

Systems and methods are provided for training an imaging system for anomaly detection through a machine learning architecture combined with a local memory optimizing, iterative sub-sampling process. Training includes separating training images into subsets and iteratively feeding each subset to the machine learning architecture which extracts patch-level features in a feature space. A sub-sampling process generates a coreset from these extracted features, each iteration. Each iteration new extracted features and the existing coreset and are fed to the sub-sampling process which updates the coreset, iteratively until all training images are consumed. To aid optimization, each iteration a convergence value indicating coreset generation progress is determined for displaying status of the anomaly detection training.

### BACKGROUND

Machine vision is a powerful tool for image-based inspection and analysis. Applications range from automatic part inspection and process control to robotic guidance, part identification, and barcode reading. System designers recognize machine vision technologies can perform many specific and complex tasks, but to do so requires integrating imaging systems with high capacity processing systems.

An important aspect of many machine vision systems is training an imaging system to perform the specific analyses and tasks desired by a customer. There are various techniques for such training. For example, sample images of a product may be fed to a trainable model, or specific features such as product defects may be fed to a model. Beyond the general, there are complex algorithmic processes that system designers deploy to analyze sample images and create trained models for machine vision systems.

An example technique for training an imaging system to detect defects in a product is the PatchCore architecture (//arxiv.org/pdf/2106.08265.pdf). PatchCore uses a pretrained backbone to extract features which are then subsampled using the k-center greedy algorithm. PatchCore provides a powerful tool for defect detection. However, a downside of using a K-center greedy algorithm is that the process requires the extracted features of the entire dataset to be loaded into memory at once. That means that the memory consumption of the algorithm is a limiting factor on lower-end hardware systems. Also, as designers in this space will appreciate, the K-center greedy algorithm does not output a loss value, which is something that deep-learning users are accustomed to seeing as it allows them to track the convergence of their training.

There is a need for better techniques for training machine vision systems for anomaly detection and, in particular, for deploying powerful techniques such as those built upon sub-sampling techniques, such as K-center greedy algorithms, but in a less computationally demanding and no less precise manner.

### SUMMARY

In an embodiment, the present invention is a method of training an imaging device for anomaly detection is provided. The method includes, in a training mode, receiving, at one or more processors, a set of training images of an object, and separating the set of training images into n subsets of the training images, where n is an integer greater than 1. The method further includes iteratively, for each subset of training images, feeding the subset of training images to a machine learning framework trained to extract patch-level features in a feature space, each patch-level feature corresponding to a different location in the subset of training images, extracting, using the machine learning framework, patch-level features for the subset of training images, and feeding the extracted patch-level features and, in response to a coreset of features being stored in a memory, feeding the coreset of features, to a sub-sampling algorithm, generating, in the sub-sampling algorithm, an updated coreset of features, and generating, at the sub-sampling algorithm, convergence values corresponding to a performance metric of the sub-sampling algorithm. The method further includes storing the updated coreset of features for use in anomaly detection on subsequently captured images of the object during an inference mode.

In variations of this embodiment, the sub-sampling algorithm is a patch-level feature selection algorithm and the convergence values corresponds to a distance metric determined by the sub-sampling algorithm.

In variations of this embodiment, the method further comprises generating a graphical display of the convergence values for each iteration for display to a user.

In variations of this embodiment, the sub-sampling algorithm comprises k-center clustering, grid sampling, furthest point sampling, statistical sampling, or random sampling.

In variations of this embodiment, the machine learning framework trained to extract the patch-level features is a convolutional neural network.

In variations of this embodiment, the set of training images of the object comprise whole images of the object.

In variations of this embodiment, the set of training images of the object comprise tile images of the object.

In variations of this embodiment, the set of training images of the object comprise images of the object at different scales.

In another embodiment, the present invention is an imaging system. The imaging system includes an imaging device configured to capture images of an object. The imaging system further includes a processor and a memory, and a computer-readable media storage having machine readable instructions stored thereon that, when the machine readable instructions are executed, cause the imaging system to: receive, at the processor, a set of training images of an object and separate the set of training images into n subsets of the training images, where n is an integer greater than 1. The computer-readable media storage includes instructions that causing the imaging system to iteratively, for each subset of training images, feed the subset of training images to a machine learning framework trained to extract patch-level features in a feature space, each patch-level feature corresponding to a different location in the subset of training images, extract, using the machine learning framework, patch-level features for the subset of training images, and feed the extracted patch-level features and, in response to a coreset of features being stored in the memory, feed the coreset of features, to a sub-sampling algorithm, generate, in the sub-sampling algorithm, an updated coreset of features, and generate, at the sub-sampling algorithm, convergence values corresponding to a performance metric of the sub-sampling algorithm. The computer-readable media storage includes instructions that causing the imaging system to store the updated coreset of features for use in anomaly detection on subsequently captured images of the object during an inference mode.

In variations of this embodiment, the sub-sampling algorithm is a patch-level feature selection algorithm and the convergence values corresponds to a distance metric determined by the sub-sampling algorithm.

In variations of this embodiment, the machine readable instructions include further instructions that, when executed, cause the imaging system to generate a graphical display of the convergence values for each iteration for display to a user.

In variations of this embodiment, the sub-sampling algorithm comprises k-center clustering, grid sampling, furthest point sampling, statistical sampling, or random sampling.

In variations of this embodiment, the machine learning framework trained to extract the patch-level features is a convolutional neural network.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates an example imaging system configured to analyze an image of a target object and execute a machine vision job, and more specifically, an anomaly detection job, in accordance with various embodiments herein.

FIG. 2 is a perspective view of an imaging device as may be used in the imaging system of FIG. 1, in accordance with various embodiments herein.

FIG. 3 illustrates an example environment for performing machine vision scanning and anomaly detection on a target object, in accordance with various embodiments herein.

FIG. 4 Illustrates an example anomaly detection architecture as may be executed by the imaging system of FIG. 1 to train an anomaly detection application stored therein, in accordance with various embodiments herein.

FIG. 5 illustrates an example architecture of a neural network trained for extracting patch-level features, as may be executed in the anomaly detection architecture of FIG. 4, in accordance with various embodiments herein.

FIG. 6 is a flowchart of an example method of training an anomaly detection application using a greedy algorithm, as may be executed by the imaging system of FIG. 1, in accordance with various embodiments herein.

FIGS. 7A and 7B are plots of convergence values versus sample index for implementations of the method of FIG. 6, in accordance with an example.

FIG. 8 is a flowchart of an example method of anomaly detection using a trained anomaly detection application (e.g., in an inference mode), as may be executed by the imaging system of FIG. 1, in accordance with various embodiments herein.

FIGS. 9A and 9B are respectively a captured image of a target object and generated heatmap indicating no detected anomalies in that captured image, as determined using an anomaly detection application trained with the method of FIG. 6, in accordance with an example.

FIGS. 9C and 9D are respectively a captured image of a target object and generated heatmap indicating numerous detected anomalies in that captured image, as determined using an anomaly detection application trained with the method of FIG. 6, in accordance with an example.

FIGS. 9E and 9F are respectively a captured image of a target object and generated heatmap indicating a single detected anomaly in that captured image, as determined using an anomaly detection application trained with the method of FIG. 6, in accordance with an example.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

For machine vision systems, image-based inspection and analysis is a core design feature. Machine vision systems are used for applications ranging from automatic part inspection, process control, robotic guidance, part identification, to barcode reading, and many others. Machine vision systems capture and process images and perform specific analyses or tasks that often require integrated use of imaging systems and processing platforms. Of particular importance, machine vision systems may be trained to perform anomaly detection, inspecting an image of a target object (e.g., a machine part) and identifying any of a series of predetermined anomalies (defects, etc.) that might occur to the part.

As described herein, the embodiments of the present disclosure may provide for more robust machine vision surface matching and object identification for various applications. In various examples, the present disclosure provides systems and methods for training an imaging device for anomaly detection. These systems and methods include capturing and receiving training images of an object and separating those training images into subsets of training images. These training images may be whole images of an object or tile images of portions of the object, collectively forming whole images. These training images may all be at the same scale, or some may be at different scales. The subsets of training images may be fed, in an iterative manner, to a machine learning framework trained to extract patch-level features in a feature space. Each of those patch-level features may correspond to a location in a training image. The machine learning framework may be a neural network, such as a pre-trained convolutional neural network. In various examples, the number of patch-level features, also termed embeddings, extracted each iteration is determined by the layer size and number of layers in that pre-trained convolutional neural network.

Extracted patch-level features from machine learning framework are provided to a patch-level features anomaly detector for generating a coreset of features. In various examples, the patch-level features anomaly detector is configured to perform under memory bank size constraints through an iterative sub-sampling process. For example, the patch-level features anomaly detector may deploy a greedy algorithm configured to generate a coreset of features.

The coreset of features generated with the present techniques represents a minimally sufficient, subsampled set of patch-level features that capture the diversity of the information contained in the training images.

The iterative sub-sampling process runs until each subset of images has been analyzed. An updated coreset is determined each iteration and stored in the constrained memory bank. Each iteration, new patch-level features are combined with the stored coreset from the memory bank, and the iterative sub-sampling process determines an updated coreset of features. The sub-sampling process may seek to satisfy the memory bank size constraint each iteration, such that the number of features in the updated coreset of features is the same size as the previously-stored coreset. In this way, in various examples, each iteration, a new coreset of features is determined, and each iteration the coreset of features is maintained at or below a determined number of features.

Further, the patch-level features anomaly detector is configured such that each sub-sampling iteration, convergence values may be stored, where these convergence values correspond to a performance metric of the sub-sampling process. In some examples, these convergence values correspond to the number of cycles of the sub-sampling process or a minimization metric of the sub-sampling process. In this way, the systems and methods may store convergence values for each iteration and display trends of that convergence value to allow system designs to assess the convergence rate and accuracy of the training of the imaging device for anomaly detection. Once all subsets of training images have been analyzed, the resulting coreset, after all of the iterations may then be stored as a the coreset of features for use in anomaly detection on subsequently captured images of the object, i.e., during an inference mode.

As described herein, the embodiments of the present disclosure may provide for accurate training of anomaly detection job scripts without placing large memory bank demands on the imaging system.

Instead, patch-level feature extraction and coreset generation may occur with reduced memory load requirements, while also allowing system designers to assess the convergence of the training process in real time, each iteration.

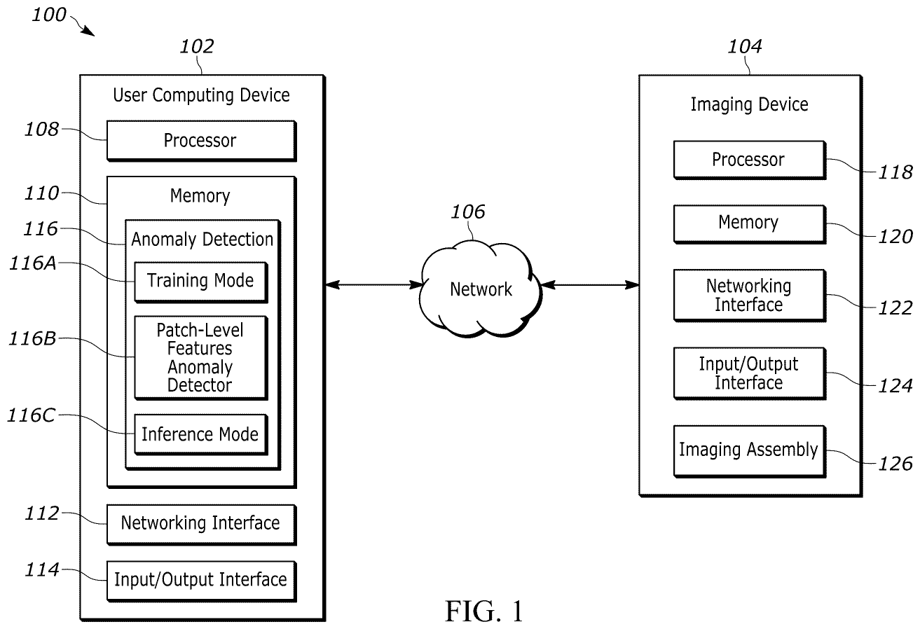

FIG. 1 illustrates an example imaging system 100 configured to analyze an image of a target object to execute a machine vision job. More specifically, the imaging system 100 is configured to train an imaging device to execute machine vision jobs that detect anomalies in target objects. In the illustrated example, the imaging system 100 includes a user computing device 102 and an imaging device 104 communicatively coupled to the user computing device 102 via a network 106. Generally speaking, the user computing device 102 and the imaging device 104 may be capable of executing instructions to, for example, implement operations of the example methods described herein, as may be represented by the flowcharts of the drawings that accompany this description. The user computing device 102 is generally configured to enable a user/operator to train an anomaly detection application at the user computing device 102. Afterwards, the user/operating can create a machine vision job, using the trained anomaly detection application, for detecting anomalies in subsequently captured images. That is, when created, the user/operator may transmit/upload the machine vision job to the imaging device 104 via the network 106, where the machine vision job is then interpreted and executed on captured image data. The user computing device 102 may comprise one or more operator workstations, and may include one or more processors 108, one or more memories 110, a networking interface 112, and an input/output (I/O) interface 114. The memories 110 may store one or more imaging applications, including, as shown an anomaly detection application 116.

The imaging device 104 is connected to the user computing device 102 via the network 106, and is configured to interpret and execute machine vision jobs and/or various surface matching and object matching jobs, received from the user computing device 102. Generally, the imaging device 104 may obtain a job file containing one or more job scripts from the user computing device 102 across the network 106 that may define the machine vision job and may configure the imaging device 104 to capture and/or analyze images in accordance with the machine vision job. For example, the imaging device 104 may include flash memory used for determining, storing, or otherwise processing imaging data/datasets and/or post-imaging data. The imaging device 104 may then receive, recognize, and/or otherwise interpret a trigger that causes the imaging device 104 to capture an image of the target object in accordance with the configuration established via the one or more job scripts. Once captured and/or analyzed, the imaging device 104 may transmit the images and any associated data across the network 106 to the user computing device 102 for further analysis and/or storage. In various embodiments, the imaging device 104 may be a “smart” camera and/or may otherwise be configured to automatically perform sufficient functionality of the imaging device 104 in order to obtain, interpret, and execute job scripts that define machine vision jobs, such as any one or more job scripts contained in one or more job files as obtained, for example, from the user computing device 102.

Broadly, the job file may be a JSON representation/data format of the one or more job scripts transferrable from the user computing device 102 to the imaging device 104. The job file may further be loadable/readable by a C++ runtime engine, or other suitable runtime engine, executing on the imaging device 104. Moreover, the imaging device 104 may run a server (not shown) configured to listen for and receive job files across the network 106 from the user computing device 102. Additionally or alternatively, the server configured to listen for and receive job files may be implemented as one or more cloud-based servers, such as a cloud-based computing platform. For example, the server may be any one or more cloud-based platform(s) such as MICROSOFT AZURE, AMAZON AWS, or the like.

In any event, the imaging device 104 may include one or more processors 118, one or more memories 120, a networking interface 122, an I/O interface 124, and an imaging assembly 126. The imaging assembly 126 may include a digital camera and/or digital video camera for capturing or taking digital images and/or frames. Each digital image may comprise pixel data, vector information, or other image data that may be analyzed by one or more tools each configured to perform an image analysis task. The digital camera and/or digital video camera of, e.g., the imaging assembly 126 may be configured, as disclosed herein, to take, capture, obtain, or otherwise generate digital images and, at least in some embodiments, may store such images in a memory (e.g., one or more memories 110, 120) of a respective device (e.g., user computing device 102, imaging device 104).

For example, the imaging assembly 126 may include a photo-realistic camera (not shown) for capturing, sensing, or scanning 2D image data. The photo-realistic camera may be an RGB (red, green, blue) based camera for capturing 2D images having RGB-based pixel data. In various embodiments, the imaging assembly may be a three-dimensional (3D) camera (not shown) for capturing, sensing, or scanning 3D image data. The 3D camera may include an Infra-Red (IR) projector and a related IR camera for capturing, sensing, or scanning 3D image data/datasets. A 3D camera may include one or more of a time-of-flight camera, a stereo vision camera, a structured light camera, a range camera, a 3D profile sensor, or a triangulation 3D imager. In various embodiments, the imaging assembly may be a hyperspectral camera or other camera that captures electromagnetic spectrum data across an image and analyzes that data for spectral signatures allowing for identifying objects and features thereof. Such spectral imaging cameras can use multiple spectral bands, for example, such as very long radio waves, microwaves, infrared radiation, visible light, and ultraviolet rays. In any of the embodiments, the imaging assemblies herein may include one or more of the example imagers describe.

In various embodiments, the imaging assembly includes a camera capable of capturing color information of a field of view (FOV) of the camera. In some embodiments, the photo-realistic camera of the imaging assembly 126 may capture 2D images, and related 2D image data, at the same or similar point in time as the 3D camera of the imaging assembly 126 such that the imaging device 104 can have both sets of 3D image data and 2D image data available for a particular surface, object, area, or scene at the same or similar instance in time. In various embodiments, the imaging assembly 126 may include the 3D camera and the photo-realistic camera as a single imaging apparatus configured to capture 3D depth image data simultaneously with 2D image data. Consequently, the captured 2D images and the corresponding 2D image data may be depth-aligned with the 3D images and 3D image data. In examples, a 3D image may include a point cloud or 3D point cloud. As such, as used herein, the terms 3D image and point cloud or 3D point cloud may be understood to be interchangeable.

In embodiments, the imaging assembly 126 may be configured to capture images of surfaces or areas of a predefined search space or target objects within the predefined search space. For example, each tool included in a job script may additionally include a region of interest (ROI) corresponding to a specific region or a target object imaged by the imaging assembly 126. The ROI may be a predefined ROI, or the ROI may be determined through analysis of the image by the processor 118. Further, a plurality of ROIs may be predefined or determined through image processing. The composite area defined by the ROIs for all tools included in a particular job script may thereby define the predefined search space which the imaging assembly 126 may capture in order to facilitate the execution of the job script. However, the predefined search space may be user-specified to include a FOV featuring more or less than the composite area defined by the ROIs of all tools included in the particular job script. It should be noted that the imaging assembly 126 may capture 2D and/or 3D image data/datasets of a variety of areas, such that additional areas in addition to the predefined search spaces are contemplated herein. Moreover, in various embodiments, the imaging assembly 126 may be configured to capture other sets of image data in addition to the 2D/3D image data, such as grayscale image data or amplitude image data, each of which may be depth-aligned with the 2D/3D image data. Further, one or more ROIs may be within a FOV of the imaging system such that any region of the FOV of the imaging system may be a ROI.

The imaging device 104 may also process the 2D image data/datasets and/or 3D image datasets for use by other devices (e.g., the user computing device 102, an external server). For example, the one or more processors 118 may process the image data or datasets captured, scanned, or sensed by the imaging assembly 126. The processing of the image data may generate post-imaging data that may include metadata, simplified data, normalized data, result data, status data, or alert data as determined from the original scanned or sensed image data. The image data and/or the post-imaging data may be sent to the user computing device 102 executing the anomaly detection application 116. In other embodiments, the image data and/or the post-imaging data may be sent to a server for storage or for further manipulation. As described herein, the user computing device 102, imaging device 104, and/or external server or other centralized processing unit and/or storage may store such data, and may also send the image data and/or the post-imaging data to another application implemented on a user device, such as a mobile device, a tablet, a handheld device, or a desktop device.

Each of the one or more memories 110, 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., anomaly detection application 116, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118 (e.g., working in connection with the respective operating system in the one or more memories 110, 120) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

As discussed herein, the anomaly detection application 116 stored in memory 110 may include a training mode 116A, a patch-level features detector 116B, and an inference mode 116C. The training mode 116A may be configured to feed training images into a pre-trained machine learning process that extracts patch-level features. The patch-level features detector 116B may be configured to control the pre-trained machine learning process in an iterative sub-sampling process that generates an evolving coreset of features under, allowing for optimizing the utilization the memory 110. For example, the patch-level features detector 116B may be configured to optimize RAM usage of the memory 110. Or in examples, where the processor 108 is wholly or partially implemented as a graphical processor unit (GPU) and the memory 110 is at least partially a video RAM (VRAM) of that GPU, the patch-level features detector 116B may be configured to optimize utilization of that VRAM. The result is that the patch-level features detector 116B working with the training mode 116A generates a coreset of features that are stored and used by the anomaly detection application 116 to analyze subsequently captured images in the inference mode 116C.

The one or more memories 110, 120 may store an operating system (OS) (e.g., Microsoft Windows, Linux, Unix, etc.) capable of facilitating the functionalities, apps, methods, or other software as discussed herein. The one or more memories 110 may also store imaging applications, which may be configured to enable machine vision job construction, as described further herein. In the illustrated example the imaging applications include the anomaly detection application 116, which is trained in accordance with techniques herein and may be configured to generate machine vision jobs.

Additionally, or alternatively, the imaging applications (such as the anomaly detection application 116) may also be stored in the one or more memories 120 of the imaging device 104, and/or in an external database (not shown), which is accessible or otherwise communicatively coupled to the user computing device 102 via the network 106. The one or more memories 110, 120 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a machine vision based imaging application, such as the anomaly detection application 116, where each may be configured to facilitate their various functionalities discussed herein. It should be appreciated that one or more other applications may be envisioned and that are executed by the one or more processors.

The one or more processors 108, 118 may be connected to the one or more memories 110, 120 via a computer bus responsible for transmitting electronic data, data packets, or otherwise electronic signals to and from the one or more processors 108, 118 and one or more memories 110, 120 in order to implement or perform the machine readable instructions, methods, processes, elements or limitations, as illustrated, depicted, or described for the various flowcharts, illustrations, diagrams, figures, and/or other disclosure herein.

The one or more processors 108, 118 may interface with the one or more memories 110, 120 via the computer bus to execute the operating system (OS). The one or more processors 108, 118 may also interface with the one or more memories 110, 120 via the computer bus to create, read, update, delete, or otherwise access or interact with the data stored in the one or more memories 110, 120 and/or external databases (e.g., a relational database, such as Oracle, DB2, MySQL, or a NoSQL based database, such as MongoDB). The data stored in the one or more memories 110, 120 and/or an external database may include all or part of any of the data or information described herein, including, for example, machine vision job images (e.g., images captured by the imaging device 104 in response to execution of a job script) and/or other suitable information.

The networking interfaces 112, 122 may be configured to communicate (e.g., send and receive) data via one or more external/network port(s) to one or more networks or local terminals, such as network 106, described herein. In some embodiments, networking interfaces 112, 122 may include a client-server platform technology such as ASP.NET, Java J2EE, Ruby on Rails, Node.js, a web service or online API, responsive for receiving and responding to electronic requests. The networking interfaces 112, 122 may implement the client-server platform technology that may interact, via the computer bus, with the one or more memories 110, 120 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some embodiments, network 106 may comprise a private network or local area network (LAN). Additionally or alternatively, network 106 may comprise a public network such as the Internet. In some embodiments, the network 106 may comprise routers, wireless switches, or other such wireless connection points communicating to the user computing device 102 (via the networking interface 112) and the imaging device 104 (via networking interface 122) via wireless communications based on any one or more of various wireless standards, including by non-limiting example, IEEE 802.11a/b/c/g (WIFI), the BLUETOOTH standard, or the like.

The I/O interfaces 114, 124 may include or implement operator interfaces configured to present information to an administrator or operator and/or receive inputs from the administrator or operator. An operator interface may provide a display screen (e.g., via the user computing device 102 and/or imaging device 104) which a user/operator may use to visualize any images, graphics, text, data, features, pixels, objects, surfaces, and/or other suitable visualizations or information. For example, the user computing device 102 and/or imaging device 104 may comprise, implement, have access to, render, or otherwise expose, at least in part, a graphical user interface (GUI) for displaying images, graphics, text, data, features, pixels, and/or other suitable visualizations or information on the display screen. The I/O interfaces 114, 124 may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the user computing device 102 and/or the imaging device 104. According to some embodiments, an administrator or user/operator may access the user computing device 102 and/or imaging device 104 to construct jobs, review images or other information, make changes, input responses and/or selections, and/or perform other functions.

As described above herein, in some embodiments, the user computing device 102 may perform the functionalities as discussed herein as part of a “cloud” network or may otherwise communicate with other hardware or software components within the cloud to send, retrieve, or otherwise analyze data or information described herein.

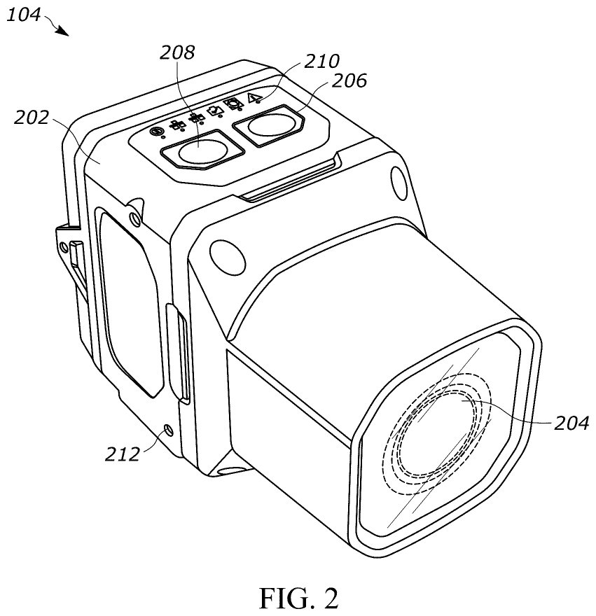

FIG. 2 is a perspective view of an example imaging device 104 that may be implemented in the imaging system 100 of FIG. 1, in accordance with embodiments described herein. The imaging device 104 includes a housing 202, an imaging aperture 204, a user interface label 206, a dome switch/button 208, one or more light emitting diodes (LEDs) 210, and mounting point(s) 212. As previously mentioned, the imaging device 104 may obtain job files from a user computing device (e.g., user computing device 102) which the imaging device 104 thereafter interprets and executes.

The user interface label 206 may include the dome switch/button 208 and one or more LEDs 210, and may thereby enable a variety of interactive and/or indicative features. Generally, the user interface label 206 may enable a user to trigger and/or tune to the imaging device 104 (e.g., via the dome switch/button 208) and to recognize when one or more functions, errors, and/or other actions have been performed or taken place with respect to the imaging device 104 (e.g., via the one or more LEDs 210). For example, the trigger function of a dome switch/button (e.g., dome switch/button 208) may enable a user to capture an image using the imaging device 104 and/or to display a trigger configuration screen of a user application (e.g., anomaly detection application 116). The trigger configuration screen may allow the user to configure one or more triggers for the imaging device 104 that may be stored in memory (e.g., one or more memories 110, 120) for use in later developed machine vision jobs, as discussed herein.

As another example, the tuning function of a dome switch/button (e.g., dome switch/button 208) may enable a user to automatically and/or manually adjust the configuration of the imaging device 104 in accordance with a preferred/predetermined configuration and/or to display an imaging configuration screen of a user application (e.g., anomaly detection application 116). The imaging configuration screen may allow the user to selectively put the imaging device 104 into a training made for capturing images and sending those images to the user computing device 102 for training the anomaly detection application 116 or in an imaging (e.g., inference) mode for capturing images and performing an anomaly detection on the capture images or for communicating images to the user computing device 102 for anomaly detection.

The mounting point(s) 212 may enable a user connecting and/or removably affixing the imaging device 104 to a mounting device (e.g., imaging tripod, camera mount, etc.), a structural surface (e.g., a warehouse wall, a warehouse ceiling, scanning bed or table, structural support beam, etc.), other accessory items, and/or any other suitable connecting devices, structures, or surfaces. While shown in this configuration, the imaging devices herein may be mounted to a robot or robotic arm or other externally controlled device. In various examples, the image devices herein may be implemented as a handheld device or as a wearable device.

In addition, the imaging device 104 may include several hardware components contained within the housing 202 that enable connectivity to a computer network (e.g., network 106). For example, the imaging device 104 may include a networking interface (e.g., networking interface 122) that enables the imaging device 104 to connect to a network, such as a Gigabit Ethernet connection and/or a Dual Gigabit Ethernet connection. Further, the imaging device 104 may include transceivers and/or other communication components as part of the networking interface to communicate with other devices (e.g., the user computing device 102) via, for example, Ethernet/IP, PROFINET, Modbus TCP, CC-Link, USB 3.0, RS-232, and/or any other suitable communication protocol or combinations thereof.

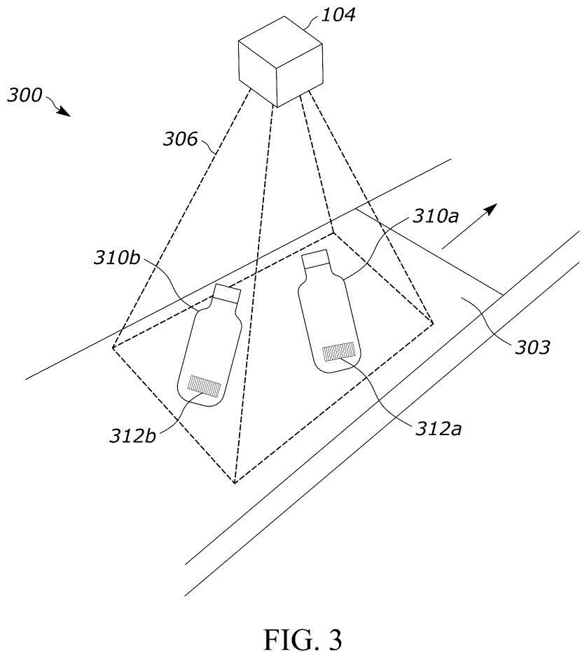

FIG. 3 illustrates an example environment 300 for performing machine vision scanning of an object as described herein. In the environment 300 of FIG. 3, the imaging device 104 of FIGS. 1 and 2 is positioned above a scanning surface 303. The imaging device 104 is disposed and oriented such that a field of view (FOV) 306 of the imaging device 104 includes a portion of the scanning surface 303. The scanning surface may be a table, podium, mount for mounting an object or part, a conveyer, a cubby hole, or another mount or surface that may support a part or object to be scanned. As illustrated, the scanning surface 303 is a conveyer belt having a plurality of objects of interest 310a and 310b thereon. The objects of interested 310a-310b are illustrated as being within the FOV 306 of the imaging device 104. The objects of interest 310a-310b may contain an indicia 312a-312b thereon, respectively. The imaging device 104 captures one or more images of the objects of interest 310a-310b and may determine a region of interest (ROI) within the image that contains the objects of interest 310a-310b. The ROI may be one or more surfaces of the objects of interest 310a-310b. The ROI may be a region that contains the indicia 312a-312b. The indicia 312a-312b may be a barcode, as shown, or any type of indicia, including one or more of 1D barcode, 2D barcode, QR code, static barcode, dynamic barcode, alphabetical character, text, numerals, alphanumeric, other characters, a picture, vehicle identification number, expiration date, tire identification number, or another indicia having characters and/or numerals.

The imaging device 104 may capture images of one or more surfaces of each of the objects of interest 310a-310b for performing anomaly detection. For example, the imaging device 104, and/or the associated imaging system 100, may identify, from 3D information from a 3D image or point cloud, an outer opening surface of a bottle (as the objects of interest 310a-310b). The imaging device 104 and/or user computing device 102 may then match that opening surface with a model surface to perform detect anomalies (e.g., defects) in that opening surface. The imaging system 100, e.g., the user computing device 102, may then perform a trained anomaly detection on the captured images of the opening surface.

The imaging device 104 may be mounted above the object of interest 310 on a ceiling, a beam, a metal tripod, or another object for supporting the position of the imaging device 104 for capturing images of the scanning surface 303. Further, the imaging device 104 may alternatively be mounted on a wall or another mount that faces objects on the scanning surface 303 from a horizontal direction. In examples, the imaging device 104 may be mounted on any apparatus or surface for imaging and scanning objects of interest that are in, or pass through, the FOV 306 of the imaging device 104.

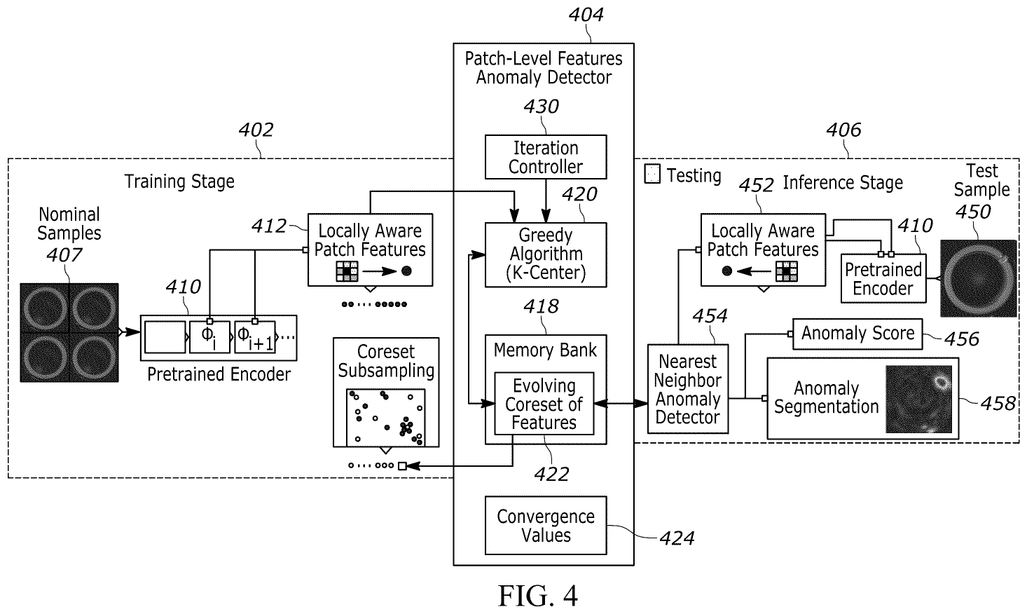

FIG. 4 illustrates an example anomaly detection architecture 400 of an anomaly detection application, as may be executed using the imaging system 100 in FIG. 1, and in accordance with the present techniques.

In the illustrated example, the anomaly detection architecture 400 is built upon a patch-level architecture designed for memory bank optimization. An example architecture is that of PatchCore, described in Roth et al., “Towards Total Recall in Industrial Anomaly Detection,” In Proceedings of the IEEE/CVF conference on computer vision and pattern recognition, pp. 14318-14328, May 2022, incorporated herein by reference it its entirety. Advantageously, a patch-level architecture can maximize nominal information available at runtime, reduce biases towards the dataset used to train a machine learning framework, and retain high inference speeds. The PatchCore architecture, in particular, relies upon generating and analyzing patches of a training image, either in parallel or sequentially. Among the advantages of PatchCore, by performing patch level analysis, an image can be classified as anomalous as soon as a single patch is anomalous. PatchCore achieves this by utilizing locally aggregated, mid-level features patches. The usage of mid-level network patch features allows PatchCore to operate with minimal bias towards classes on a high resolution, while a feature aggregation over a local neighborhood ensures retention of sufficient spatial context. Unfortunately, this can result in the need for an extensive memory bank, allowing PatchCore to optimally leverage available nominal context at test time. To that end, the patch-level architectures of the present techniques use a greedy coreset sub-sampling for nominal feature memory banking. The coreset sub-sampling reduces the memory bank demands, by reducing redundancy in the extracted, patch-level features. The required amount of storage memory is significantly reduced, as a result, while the architecture is able to reduce and inference time.

In the illustrated example, the anomaly detection architecture 400 includes a training stage 402, a patch-level features anomaly detector 404, and an inference stage 406 (e.g., a testing stage, a runtime stage, etc.).

The anomaly detection architecture 400 is described, in an example, as implemented using the imaging system 100.

During the training stage 402, training images 407 are fed to the user computing device 102.

These training images may be stored in a computing device, server accessible database, etc. that is coupled to the network 106. Alternatively, or additionally, the training images 407 may be stored in the memory 110 and/or received from the imaging device 104 capturing images of target objects in a FOV. The training images may be of any target object for which the anomaly detection architecture 400 is to be trained for subsequent analysis of images during the inference stage 406.

The patch-level features anomaly detector 404 controls the training stage 402 by imposing an iterative sub-sampling process on the training stage 402. In the illustrated example, the patch-level features anomaly detector 404 includes an iteration controller 430 that instructs the training stage 402 to separate the received training images 407 into k subsets of training images. Each subset may contain the same number of training images. Although, in some examples, different subsets have different numbers of training images. Further, each subset may contain images of the same resolution, or some subsets of images may have images at different resolutions. Further, the training images 407 may be whole images of an object. While in other examples, the training images 407 may be tile images of portions of an object. In any case, the iteration controller 430 imposes an iterative sub-sampling process on the training stage 420. In a first iteration, a first subset of the training images 407 is fed to a pretrained machine learning backbone, e.g., a pretrained neural network 410, for example, a pretrained encoder. The pretrained neural network 410 is configured to extract patch-level features 412 for the subset of training images. The extracted patch-level features 412 represent points in a feature space.

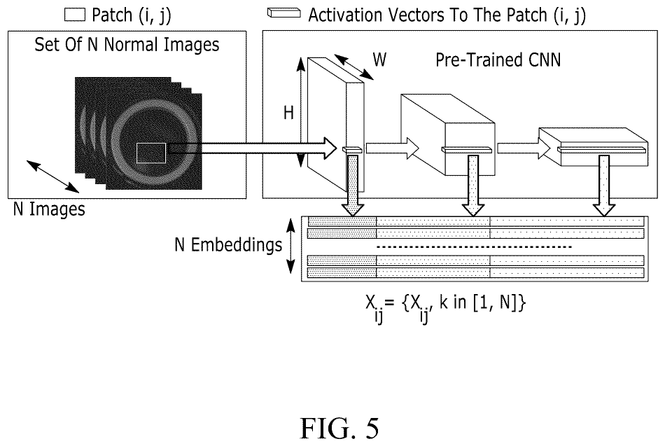

The pretrained neural network 410 may have various configurations. An example configuration is described in Defard et al., “PaDiM: a Patch Distribution Modeling Framework for Anomaly Detection and Localization,” In International Conference on Pattern Recognition, 2021, pp. 475-489, incorporated herein by reference it its entirety. The pretrained neural network 410 can be configured to extract different patch-level features at different backbone layers thus forming a deep learning architecture. Each backbone layer may be an encoder for example, and each may be configured to extract different features. From a deep learning framework point of view, these backbone layers may generate tensors passed between the backbone layers. The backbone layers may have different height and width dimensions of a latent feature space, where those different height and width dimensions are related to the height and width of the input image, but they are reduced in size because the backbone layers down sample spatial information more and more each layer. The objective of the down sampling is twofold. Down sampling reduces the quantity of information to process while aggregating the information from neighboring pixels into a single latent feature vector. The latent feature vectors consist of all the values along the third dimension of the latent feature space for any given coordinates (x, y). That third dimension is usually referred to as the channel dimension of the tensor. Finally, we can assume that each latent feature vector (x,y) is related to a neighborhood of pixels in the image, that is the image patch (i,j). FIG. 5 illustrates an example architecture 500 of the pretrained neural network 410, receiving the training images and producing an embedding for each training image, where the patch-level features are extracted from these embeddings. As apparent in FIG. 5, the number of patch-level features that may be extracted for a subset of training images will be very large, e.g., N embeddings would result in N×H×W patch-level features.

As will be appreciated, the further into the backbone layers, new latent features are formed by combining features form earlier latent feature spaces to form a greater number of more expressive patch-level features. To compensate for this increase of information, in the illustrated example, the backbone layers down sample spatial information, making these latent spaces less high and wide. To get the features of an image, all latent feature spaces are up-sampled spatially to be as high and wide as the first one before being concatenated together. Thus at (x,y) you get the complete feature vector of patch (i,j).

In the illustrated example of FIG. 5, convolutional neural network (CNN) layers are pretrained to output relevant features for use in anomaly detection during the inference mode 406. In the illustrated example, to avoid ponderous neural network optimization only pretrained CNN layers were used to generate patch features vectors. In other examples, the pretrained neural network may be replaced with an untrained neural network or partially-trained neural network. For the example of FIG. 5, during the training phase, each patch of the normal images is associated to its spatially corresponding activation vectors in the pretrained CNN activation maps. Activation vectors from different layers are then concatenated to get features vectors carrying information from different semantic levels and resolutions, in order to encode fine-grained and global contexts. As activation maps have a lower resolution than an input image, many pixels may have the same features and then form pixel patches with no overlap in the original image resolution. Hence, an input image can be divided into a grid of (i, j) ∈[1, W]×[1, H] positions where W×H is the resolution of the largest activation map used to generate features. Finally, each patch position (i, j) in this grid is associated to a features vector xᵢⱼ. The generated patch features vectors may carry redundant information. Therefore, in some examples, randomly selecting a few dimensions may be used to reduce dimensionality. This simple random dimensionality reduction may decrease the complexity of our model for both training and testing time while maintaining the state-of-the-art performance.

The patch-level features anomaly detector 404 is configured to optimize utilization of a memory bank 418, which may be RAM or VRAM memory, portion of the memory 110, etc. The iterative sub-sampling process imposed by the iteration controller 430, for example, can generate coreset features with a memory bank having a much smaller size than would be required by a configuration like that of PatchCore. For example, the iteration controller 430 instructs the training stage 402 to separate the training images 407 into k subsets of the training images, where k is an integer greater than 1 and may be set based on the memory size of a memory bank 418 of the patch-level optimizer stage 404. The larger k is the more interactions will be performed by the training stage 402, while the smaller the memory demands placed on the memory back 418. Described another way, in some examples using PatchCore (and this would apply to other representative architectures) the present techniques are able to advantageously generate a coreset that is the same size as conventional PatchCore, while addressing memory constraints. The main memory constraint comes from the fact that in conventional PatchCore one needs to load patch-level features from the entire dataset into memory before being able to generate the coreset of features. With the iterative processes described in various examples herein, the architecture can access and load only a portion of the patch-level features into RAM/VRAM at a time, which means that the architecture can train on as many images as desired without having memory constraints and that allows an architecture to train on more images and larger images sizes since there is a more memory efficient process.

After each k subset of training images is fed to the pretrained neural network 410, a set of patch-level features 412 is generated. In response, the patch-level features anomaly detector 404 feeds the patch-level features 412 to a sub-sampling algorithm configured to reduce the number of patch-level features into a coreset of features. As noted above, a coreset of features represents a minimally sufficient, subsampled set of patch-level features that capture the diversity of the information contained in the training images. Various sub-sampling algorithms may be deployed to determine a coreset for each iteration. These include k-center clustering, grid sampling, furthest point sampling, statistical sampling, or random sampling, among others. In the illustrated example, the sub-sampling algorithm is a greedy algorithm 420, such as a K-center greedy algorithm.

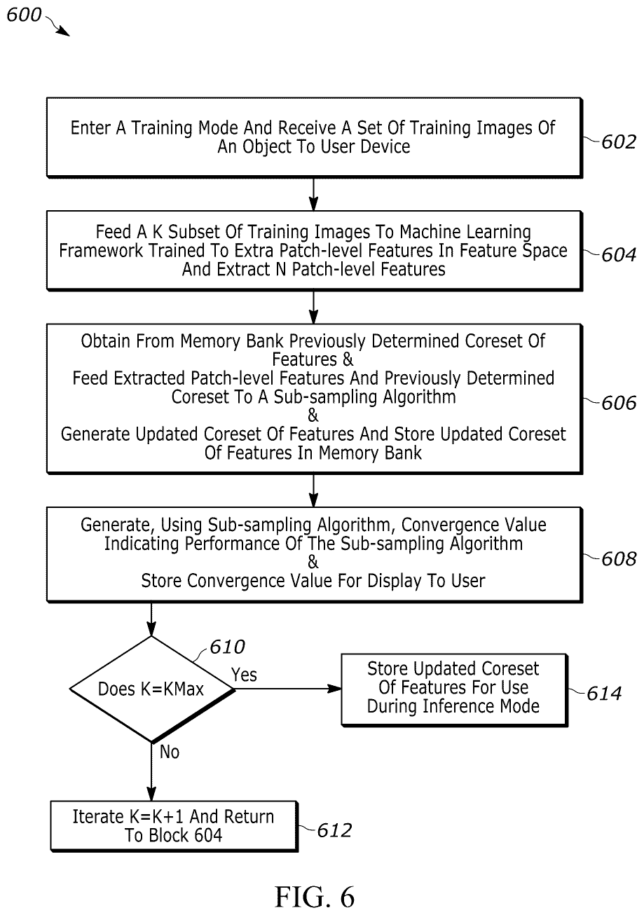

In particular, each iteration, the sub-sampling algorithm 420 (e.g. the greedy algorithm 420—although this could be performed by the controller 430) accesses the memory bank 418 and any previously-stored coreset of features 422 stored therein. The sub-sampling algorithm 420 appends the newly determined patch-level features 412 to the currently stored coreset 422, and the sub-sampling algorithm 420 performs a sub-sampling process on the combined feature set to determine an updated coreset of features. That updated coreset may have the same number of features as the previously-stored coreset, but responsive to the sub-sampling process would most likely include a new set of the patch-level features. That is, the sub-sampling algorithm 420 is configured to determine an updated coreset of features, representing an even stronger minimally sufficient set of patch-level features of the object in feature space, while maintaining the same utilization (e.g., size) requirements of the memory bank 418. The coreset of features generated each iteration, i.e., for each k subset of training images and k iteration, is stored in the memory bank 418 as the updated coreset 422 for use in the next iteration, replacing the previously-determined coreset. In this way, in some examples, the patch-level features anomaly detector 404 may be configured to perform an optimization on patch-level features each iteration, generating across iterations, an evolving and increasingly more accurate coreset of features, until all iterations are complete, i.e., until all k subsets of training images have been analyzed by the pretrained neural network 410 of the training stage 402. As discussed above, in various examples, the iterative sub-sampling is performed using coresets, which are themselves feature sets that have been subsampled down to a coreset, for example, using processes as described herein, or through other suitable techniques. Further examples of training are described in the methods described and illustrated herein, including that of FIG. 6.

After the k iterations are completed, i.e., the k subsets of training images have been analyzed, the final iteration coreset of features is stored as the coreset of features, in feature space, that are to be used by the anomaly detection application during the inference stage 406 for detecting anomalies in subsequently captured images of object. That is, in various embodiments, the coreset 422 is stored in the memory 110 for access by the anomaly detection application 116. In some such examples, anomaly detection is performed at the user computing device 102, for example, in response to receiving subsequently captured images from the imaging device 104. In others examples, the coreset 422 may be stored in the memory 120 of the imaging device 104, and the imaging device 104 may be is configured to execute an anomaly detection application stored in memory 120.

In addition to performing iterative sub-sampling, the patch-level features anomaly detector 404 may also generate convergence values 424 each iteration. These convergence values are generated by the sub-sampling algorithm 420, e.g., by the K-center greedy algorithm. The convergence values correspond to a performance metric of the sub-sampling algorithm 420. For example, sub-sampling processes configured as a patch-level feature selection algorithm such as a K-center greedy algorithm, are themselves iterative requiring multiple cycles to converge a performance metric. In some examples, convergence values correspond to the number of cycles of the sub-sampling process or to a minimization metric of the sub-sampling process, such as a distance between patch-level features used in forming the coreset. The convergence values 424 may be stored in the memory back 418 or separate from the memory bank 418, such as elsewhere in the memory 110. Further the patch-level features anomaly detector 404 may accumulatively store the convergence values each iteration for display to a user as a graphical indication of the convergence of the sub-sampling process 420. In this way, the convergence values 424 can be used to assess the number of cycles performed each iteration, allowing designers to configure the sub-sampling process 420 to execute fewer or greater numbers of optimization cycles, when determining a coreset. In various examples, the convergence value is a value that can be analyzed to determine whether designers can reduce or increase the number of patch-level features that are selected by the sub-sampling algorithm. In various examples, convergence values can be used to compare multiple trainings.

As illustrated, in various examples the inference stage 406 may be implemented as a testing stage to confirm convergence of the training stage 402.

In an example, during testing, a test image 450 is received at the user computing device 102. For example, the imaging device 104 may have captured a 2D color image or 3D image of a test object. The inference stage 406 may or may not be configured to perform a whole image analysis or a tile image analysis, for example, where a whole image of an object is taken and that whole image is separated into tiles which may then be individually analyzed, whether in a sequential manner or in parallel with other tiles.

In the illustrated example, the test image 450 is fed to the pretrained neural network 410, which generates patch-level features 452, which are in a feature space as were features 412. The patch-level features 452 are provided to an anomaly detection application 454, which is a nearest neighbor anomaly detector in the illustrated example. In response to receiving the patch-level features 452, the anomaly detection application 454 communicates to the patch-level features anomaly detector 404 for accessing the stored coreset of features 422. The anomaly detection application 454 performs a nearest neighbor analysis for each feature in the coreset 422. In some examples, the anomaly detection application 454 performs a minimization process, e.g., a nearest neighbor process, that compares the received features 452 to the coreset 422 and a minimum distance to the features of the coreset 422 is measured for each feature 452, from which an anomaly score 456 is computed based on these distances. The anomaly scores for each patch-level feature 452 may be generated and stored and, as shown, displayed to a user as an anomaly segmentation image 458. In various examples, the anomaly detection application 454 determines an anomaly score 456 for the entire test image 405 and stores that value for display to user. In some examples, the image-level anomaly score 456 may be determined as the maximum distance between any of the patch-level features 452 and its nearest neighbor from the coreset 422. The anomaly score 456 is used to generate the anomaly segmentation image 458. For example, such image-level anomaly scoring may be performed as described in Roth et al., “Towards Total Recall in Industrial Anomaly Detection,” In Proceedings of the IEEE/CVF conference on computer vision and pattern recognition, pp. 14318-14328, May 2022. In other examples, the image score is the maximum distance from the anomaly segmentation map.

FIG. 6 illustrates a flowchart for a method of performing training an anomaly detection application of an imaging system. The method of FIG. 6 may be implemented using the imaging system 100 of FIG. 1, for example using the user computing device 102 and the imaging devices 104 of FIGS. 1-3. Process 600 begins at block 602, with the imaging system 100 entering a training mode, in which the user computing device 102 receives a set of training images of an object. At a block 604, the training images are separated into k subsets of training images. In some examples, the block 604 may set a maximum value for k, kₘₐₓ, to a predetermined value. In other examples, the block 604 may determine a suitable value for k based on the size of the memory 110, such as the size the memory bank allocated to the anomaly detection application 116, and/or based on the size the of training images (i.e., the pixel size).

At the block 604, the process 600 feeds a first (k=0) subset of the training images to a machine learning framework trained to extract patch-level features in a feature space. Each patch-level feature corresponds to a different location in a training image, but in a feature space, not in a (physical) image space. In response, the trained machine learning framework extracts patch-level features at the block 604.

The extracted patch-level features of block 604 are fed to a sub-sampling algorithm at a block 606. In response, the block 606 obtains request from a memory bank a previously determined coreset of features. If no coreset exists, for example, during the first iteration of the process 600, the block 606 does not obtain a coreset.

The block 606 feeds the extracted patch-level features from block 604 and the obtained coreset of features to a sub-sampling algorithm that is configured to generate an updated coreset of features. The block 606 then stores the updated coreset for access in the next iteration of the process 600. In some examples, the block 606 is configured such that the sub-sampling algorithm includes a K-center greedy optimization as described in Sener et al., “Active Learning For Convolution Neural Networks: A Core-Set Approach,” In International Conference on Learning Representations, June 2018, hereby incorporated by reference, may be applied by the block 610.

At a block 608, convergence values are generated by the sub-sampling process of the block 606, and these convergence values may be stored and displayed to user. A convergence value, for example, may be the value of the expression that is optimized in performing the K-center greedy algorithm as the sub-sampling process of block 606. For example, in some implementations, the block 608 performs a k-greedy algorithm to optimize an expression, s, in accordance with the following:

Algorithm 1 k-Center-Greedy

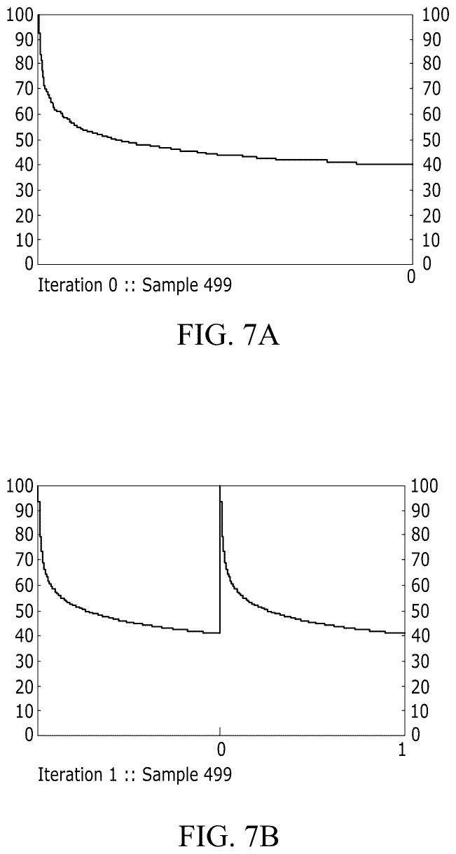

```
Input: data x [symbol] , existing pool s⁰ and a
budget b
Initialize s = s⁰
repeat
  u = arg max_{i∈[n]\s} min_{j∈s} Δ(xᵢ, xⱼ)
  s = s ∪ {u}
until |s| = b + |s⁰|
return s \ s⁰ [symbol]
indicates data missing or illegible when filed
```

where xᵢ represents the subset of training image patches (as a large collection of data points), s⁰ represents an initial pool of data points that may be chosen randomly, b represents a budget, and u represents the next feature which is being added to the coreset for optimization. In such examples, the convergence value may be defined by maxi∈[n]\sminj∈sΔ(xᵢ,xⱼ). The convergence values of block 608 may be presented to a user of the computing device 102, for example, to a display connected to the I/O interface 114. In an example, the convergence values are displayed in a loss convergence vs sample cycle plot, examples of which are shown in FIGS. 7A and 7B. The loss plot in FIG. 7A illustrates an example of a first iteration process, i.e., of a first, single set of training images is used by the process 600 to train the anomaly detection application 116. The loss plot of FIG. 7B illustrates an example of a two iteration process, where a second subset of images has been used by the process 600. Each iteration represented may include multiple images of the object, such that each iteration contains multiple images. These images for the different iterations (of FIGS. 7A and 7B) may be separate tiles of a single training image of the object. These images may be partially overlapping portions of a single image of the object. These images may be of the object taken at different scales, i.e., at different resolutions. The images may be at different brightness levels, for example, an image of the object with a low brightness level (closer to a brightness value of 0) and the other image with a brightness level closer to a high brightness level (closer to a brightness value of 255). The images may each be entire images of the object. When comparing FIG. 7B to FIG. 7A in the illustrated example, the same sample index (e.g., 499 cycles and representing a convergence time of the k-center greedy optimization) was achieved each iteration. This demonstrates the robustness of the present techniques to quickly reach a coreset of features each iteration through a multicycle optimization.

At a block 610, the process 600 determines if k is kₘₐₓ, indicating that all k subsets of training images have been analyzed by the process 600. If the condition at block 610 is satisfied, then control passes to block 614 where the optimized coreset is stored for anomaly detection in subsequently captured images received from the imaging device 104, such as during a runtime operation, including for example the inference stage 406. If the condition for block 619 is not met, control passes to a block 612 which iterates to the next (k=k+1) subset of training image patches and control is passed to passed to block 604.

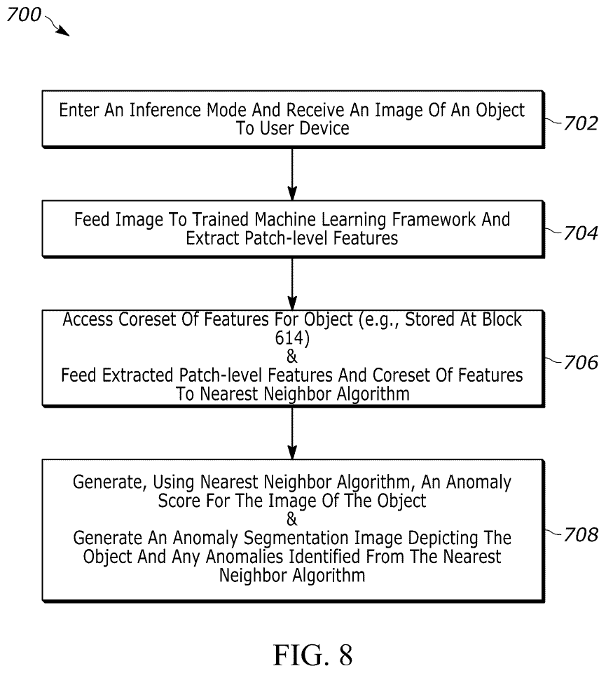

FIG. 8 is a flowchart of a method for anomaly detection, e.g., using a trained anomaly detection application in an inference mode, as may be implemented using the imaging system 100 of FIG. 1, for example the user computing device 102 and the imaging devices 104 of FIGS. 1-3. Process 700 begins at block 702, with the imaging system 100 entering an inference mode, in which the user computing device 102 receives an image of an object. At a block 704, the process 700 feeds the image to a machine learning framework trained to extract patch-level features in a feature space. In various examples, the same machine learning framework executed at block 604 of process 600 is used at block 704 to extract patch-level feature of the image captured during inference.

At a block 706, the process 700 accesses the coreset of features for the object generated at the block 614 of process 600. In some examples, the imaging devices executing process 700 have been configured to access the coreset corresponding to the object being imaged during the inference mode. In other examples, the imaging devices executing the process 700 may be configured to perform initial imaging processing to identify the object and then select from amongst a plurality of a stored coreset of features for different objects, the coreset that corresponds to the identified object.

The block 706 feeds the coreset of features and the extracted patch-level features from the block 704 to a nearest neighbor algorithm, for example, executed by the nearest neighbor anomaly detector 454. At a block 708, a nearest neighbor process compares the extracted patch-level features of block 704 to the coreset of features and determines an anomaly score for the image captured at block 702. The block 708 further generates an anomaly segmentation image, for example, in the form of a heatmap image, as discussed in various examples herein.

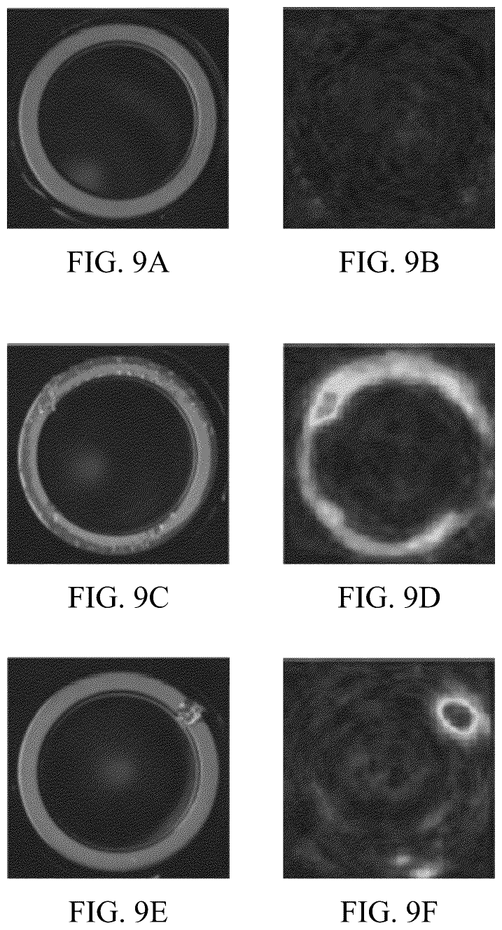

FIGS. 9A-9F illustrate different examples of images of a target object (an opening mouth of a bottle captured from a top down view) and resulting images generated by the anomaly detection application 116 trained according to an example herein. The resulting images, in these examples, are generated heatmap images, where higher intensity pixel regions correspond to anomalies identified in the corresponding captured image. For example, FIG. 9A is an image of a bottle opening captured by an imaging device and communicated to a user computing device having a trained anomaly detection application. The image in FIG. 9A shows no defects, and correspondingly the heatmap image in FIG. 9B generated by the trained anomaly detection application shows no defects. FIG. 9C is an image of a bottle opening showing many defects around the entire ring of the bottle opening. Correspondingly, the trained anomaly detection application has generated a heatmap (FIG. 9D) indicating many hotspots that confirm the detection of many anomalies, each corresponding to one or more defects. Similarly, FIG. 9E illustrates a bottle opening where the defect is larger than the defects apparent in the image of FIG. 9C and where the defect is isolated in an upper right corner of the bottle opening. That is, there are no other discernable defects. As shown in FIG. 9F, the trained anomaly detection application has identified that large defect in the generated heatmap.

As shown, the present disclosure provides techniques for training an imaging system to perform anomaly detection. That training relies upon a machine learning architecture that extracts patch-level features and that includes a sub-sampling process that generates a subsampled coreset of features from those extracted patch-level features. For example, a greedy algorithm, such as a k-center greedy algorithm is used to generate a coreset. The training is also characterized, in various examples, by reducing a memory bank demand, through generating the coreset in an iterative manner. Training images may be separated into a plurality of subsets, where each subset is analyzed each iteration, thereby reducing the memory bank size needed to store extracted patch-level features. Instead of storing all possible extracted features from training data, each iteration, a memory bank may store only a coreset of extracted patch-level features. This allows the training process to retain a sufficient minimum number of patch-level features each iteration. Further, to allow the coreset of features to be iteratively optimized, each iteration the extract features of that iteration are combined with the stored coreset of features and both are provided to the sub-sampling process which generates an updated coreset

A further feature of the present disclosure is that various training processes also allow system designers to view the progress of the training by generating, each training iteration, convergence values that indicate a progress of the training process.

In various examples, training includes separating training images into subsets of image, e.g., subsets of whole images or subsets of tiles of whole images, and iteratively feeding each subset to machine learning backbone, such as neural network. That backbone may be a multilayered convolution neural network configured to extract patch-level features of a target. Each iteration a subset of the images is analyzed by the backbone, features are extracted, and a coreset of features are updated through a sub-sampling algorithm assessing the previously-stored coreset that resulted from a previous iteration and the features extracted the current iteration. This iterative sub-sampling process continues until all subsets of training images have been analyzed. The coreset of the last iteration then is stored as the minimally sufficient, subsampled set of features that capture the diversity of information contained in the training images of the object.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines.

Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present).

Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method of training an imaging device for anomaly detection, the method comprising:
in a training mode, receiving, at one or more processors, a set of training images of an object;
separating the set of training images into n subsets of the training images, where n is an integer greater than 1;
iteratively, for each subset of training images,
feeding the subset of training images to a machine learning framework trained to extract patch-level features in a feature space, each patch-level feature corresponding to a different location in the subset of training images,
extracting, using the machine learning framework, patch-level features for the subset of training images, and feeding the extracted patch-level features and, in response to a coreset of features being stored in a memory, feeding the coreset of features, to a sub-sampling algorithm,
generating, in the sub-sampling algorithm, an updated coreset of features, and
generating, at the sub-sampling algorithm, convergence values corresponding to a performance metric of the sub-sampling algorithm; and
storing the updated coreset of features for use in anomaly detection on subsequently captured images of the object during an inference mode.

2. The method of claim 1, wherein the sub-sampling algorithm is a patch-level feature selection algorithm and the convergence values corresponds to a distance metric determined by the sub-sampling algorithm.

3. The method of claim 2, the method further comprising generating a graphical display of the convergence values for each iteration for display to a user.

4. The method of claim 1, wherein the sub-sampling algorithm comprises k-center clustering, grid sampling, furthest point sampling, statistical sampling, or random sampling.

5. The method of claim 1, wherein the machine learning framework trained to extract the patch-level features is a convolutional neural network.

6. The method of claim 1, wherein the set of training images of the object comprise whole images of the object.

7. The method of claim 1, wherein the set of training images of the object comprise tile images of the object.

8. The method of claim 1, wherein the set of training images of the object comprise images of the object at different scales.

9. An imaging system comprising:
an imaging device configured to capture images of an object;
a processor, a memory, and a computer-readable media storage having machine readable instructions stored thereon that, when the machine readable instructions are executed, cause the imaging system to:
receive, at the processor, a set of training images of an object;
separate the set of training images into n subsets of the training images, where n is an integer greater than 1;
iteratively, for each subset of training images,
feed the subset of training images to a machine learning framework trained to extract patch-level features in a feature space, each patch-level feature corresponding to a different location in the subset of training images,
extract, using the machine learning framework, patch-level features for the subset of training images, and feed the extracted patch-level features and, in response to a coreset of features being stored in the memory, feed the coreset of features, to a sub-sampling algorithm,
generate, in the sub-sampling algorithm, an updated coreset of features, and
generate, at the sub-sampling algorithm, convergence values corresponding to a performance metric of the sub-sampling algorithm; and
store the updated coreset of features for use in anomaly detection on subsequently captured images of the object during an inference mode.

10. The imaging system of claim 9, wherein the sub-sampling algorithm is a patch-level feature selection algorithm and the convergence values corresponds to a distance metric determined by the sub-sampling algorithm.

11. The imaging system of claim 9, wherein the machine readable instructions include further instructions that, when executed, cause the imaging system to generate a graphical display of the convergence values for each iteration for display to a user.

12. The imaging system of claim 9, wherein the sub-sampling algorithm comprises k-center clustering, grid sampling, furthest point sampling, statistical sampling, or random sampling.

13. The imaging system of claim 9, wherein the machine learning framework trained to extract the patch-level features is a convolutional neural network.

14. The imaging system of claim 9, wherein the set of training images of the object comprise whole images of the object.

15. The imaging system of claim 9, wherein the set of training images of the object comprise tile images of the object.

16. The imaging system of claim 9, wherein the set of training images of the object comprise images of the object at different scales.
